(19) United States
(12) Patent Application Publication
(10) Pub. No.: US 2012/0101954 A1
(43) Pub. Date: Apr. 26, 2012

(54) Multiple Site Profile and Transfer of Information

(76) Inventor: Scott C. Harris, San Diego, CA (US)

(21) Appl. No.: 13/279,255

(22) Filed: Oct. 22, 2011

Related U.S. Application Data
(60) Provisional application No. 61/405,763, filed on Oct. 22, 2010.

(51) Int. Cl. G06Q 99/00

(52) U.S. Cl. 705/319

(57) ABSTRACT

Profile information is shared between websites. A multi site profile can be used which has information for use on a social networking site which includes information about connections and lifestyle preferences on the social networking site, and on an item purchase site which includes information about successful items purchased on the item purchase site, and on a gaming website, which includes information about characters on the gaming website, and items associated with the profile, gaming website. The profile can be used on the different sites, and receive updates from the different sites.

### BACKGROUND

Certain kinds of electronic websites maintain information about people who visit or otherwise use various websites. For example, user-to-user selling sites such as eBay often maintain profiles about the users and information about their shopping and selling history. Different kinds of websites, however, maintain different kinds of information. Social networking sites such as Facebook maintains profiles about a person's likes, and dislikes, their friends, and their various kinds of history on the website. Gaming sites, such as “World of Warcraft” may maintain a profile about a user's history of gaming on the website.

### SUMMARY

The present application recognizes that even though the different websites keep different kinds of information, that a portable profile that could be used on multiple different websites can provide additional information and could provide more security among the websites than is currently possible.

Embodiments describe a portable profile that can be used between websites. According to one embodiment, this profile may have different lists of information. Another embodiment describes use of encryption to maintain the security of this kind of profile.

### BRIEF DESCRIPTION OF THE DRAWINGS

FIG. 1 and others show embodiments.

### DETAILED DESCRIPTION

An embodiment recognizes that a number of different websites maintain profiles about users. While many of these profiles have overlapping information (such as user name, address, and the like) many of the websites profiles have unique information. For example, the eBay profile system maintains information about transactions that users have carried out. This profile is unique to the eBay website, but provides at least a measure of the user's fiscal responsibility. Many users go through significant effort to maintain their ebay profile.

Other sites may maintain information about the behavior of the user, for example the user might get chastised or banned for carrying out some unlawful behavior.

In many of these sites, the user names are often not verified in any way. A user who does bad things, and gets a bad rating or profile, can simply make up a new name. Users may keep good profiles, and give up any bad profiles.

This segues into yet another problem: that users can typically make up any part of their profile, because these profiles are typically not verified in any way.

Also, building up goodwill on a site such as eBay is only good for that one site.

The present inventor recognizes that websites might want to know more information about users, but users typically resist putting too much information into a website profile, because of the work involved in doing this.

The present application describes a multisite profile that can be used between different sites. The profile provides the ability for any of a number of different sites to modify the profile. According to an embodiment, security is added to the profile, to enhance the security on the website, and also enhance the usability of the profile.

Embodiments describe a multisite profile that can describe a user and can be used between multiple sites. In an embodiment, this profile may be a file that is stored on some storage device, e.g. on the Internet, on a flash drive, or a portable telephone for example. The profile is updated based on operations carried out on multiple different websites.

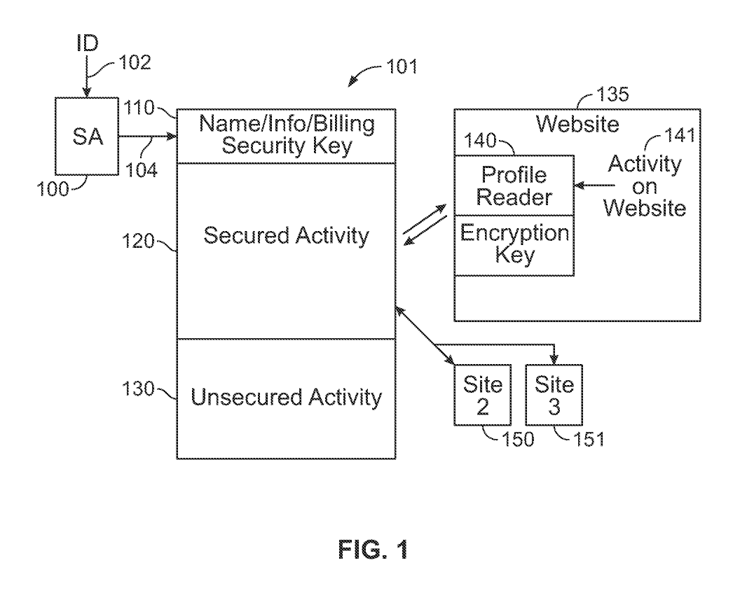

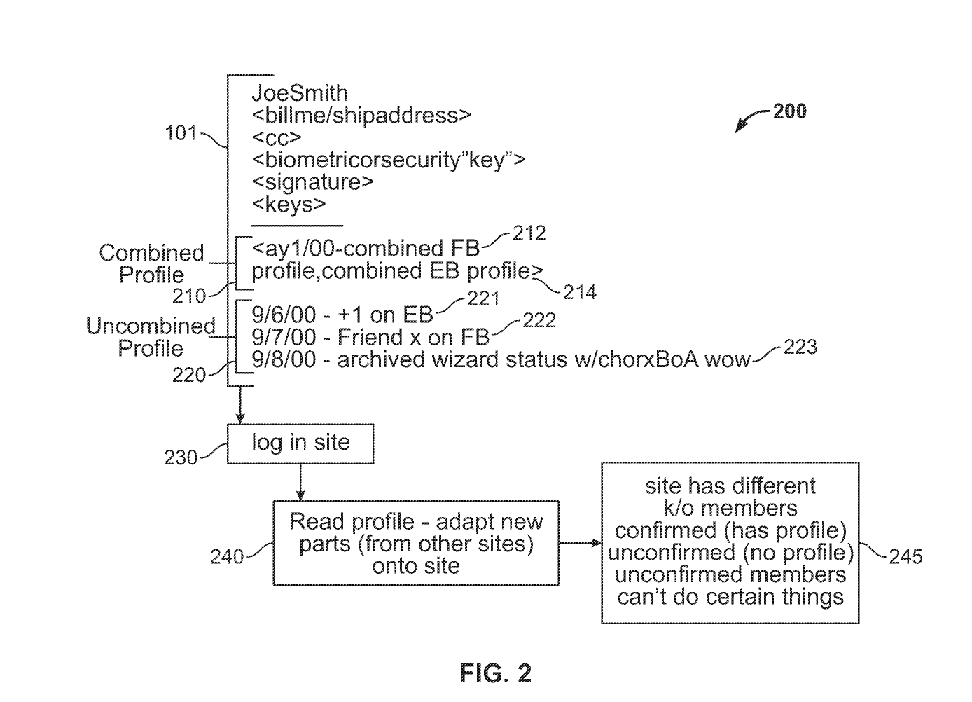

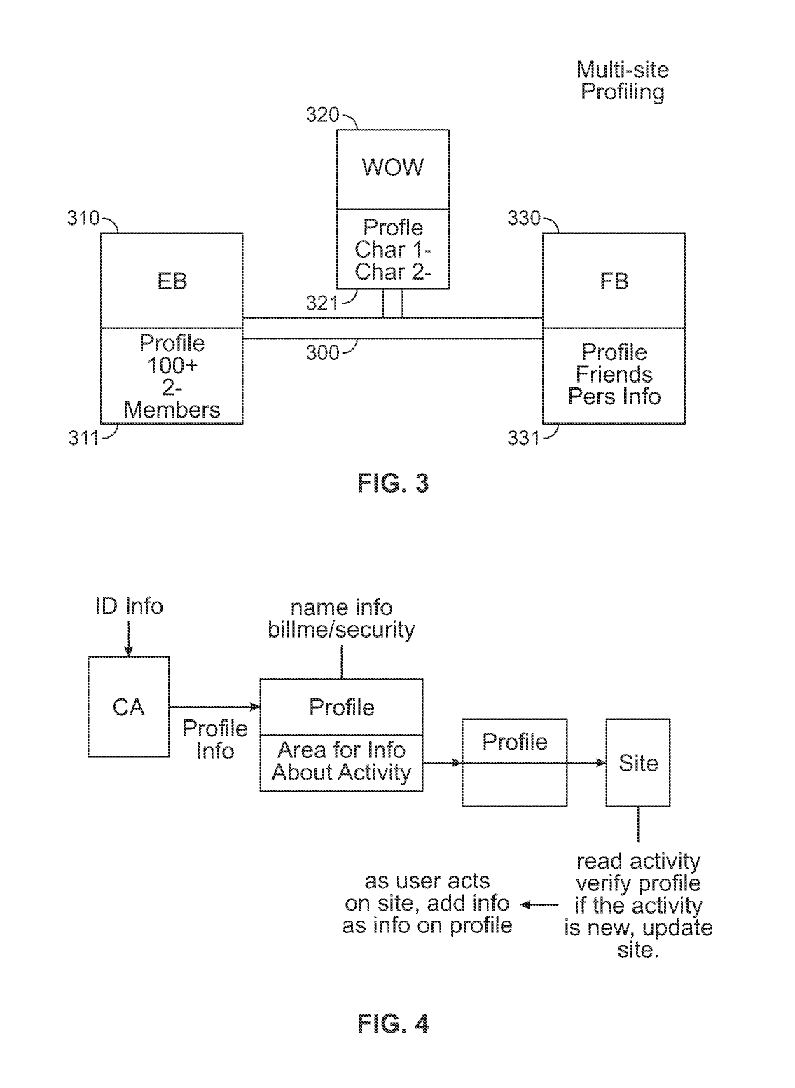

FIG. 1 shows how a user can create a highly secured website using a certificate/signing authority site “SA” 100. More generally, any cryptographically secure site or program can be used for this purpose. The signing authority is typically a trusted site that is known to the user. The user enters their ID information 102, and the site outputs at 104 either a new profile or an update to an existing profile. The profile typically has different parts. The personal information part shown as 110 which can be for example the user's name, information, billing information, and security. A second part of the profile 120 is a secured activity area. This provides information about a user's activities, but maintains the security of this information so that the information cannot be tampered with. A third part 130 is an unsecured activity area, which may provide any of a number of different sites for the user to enter information themselves about user activity.

FIG. 1 also illustrates how the profile can be used on a number of different sites. The profile 101 for example can be read by site_1 using an encryption key to read the secured activity portion. The profile reader 140 in site_135 may read this information and verify the profile. The profile reader 140 can also read the activity 141 that is occurring or has occurred on the site 135. If the activity 141 or any of the profile is new, e.g., that it is different than the profile that is already stored on the site 135, then the site 135 may be updated to indicate information about the new activity and/or the new profile.

For example, the profile may include a number of friends on Facebook. The activity may include interacting with those friends, or may include making new friends. Either the activity (interacting with friends) or the profile 101 may have different friend information send the local friend information on the site. For example, the profile 101 may be out of date relative to what is happened on the site. Alternatively, the profile 101 may be more up-to-date with new kinds of friends from some other site or some other activity than the friends on the site 135. If the friends on the site 135 are different than the profile 101, then the site 135 may update its information to include the new profile information indicative of the new friends from the profile. Conversely, if there are additional friends on the site 135 (using the example of Facebook) relative to the friends listed on the profile 101, then those friends are added to the profile 101, in a way that allows them to be used on some other site.

In a similar way, as the user acts on any linked site shown generically as 150 and 151, information from the user activities may be added to the profile and then correspondingly added to other sites.

FIG. 3 shows how the different sites exist, each with their own profile. The Internet is shown generally as 300, and connects to eBay 310; World of Warcraft 320 and Facebook 330. More generally, these sites can be any website that stores a profile, including any kind of user purchase site, a gaming site, a social networking site, Bank site, or any other kind of site.

Each of these sites maintain a profile about the user.

The eBay site 310 maintains a profile 311 which indicates a number of successful purchases, as well as things like feedback. The World of Warcraft site maintains a profile indicating information about the user's purchases.

The Facebook site maintains a profile of the user's friends and personal information.

Some of these sites have the same information. The sites may require a user to identify themselves, e.g., using a credit card. This identifies the user by their specific credit card. The same user, however, can use a different credit card to create a different profile.

Moreover, building up goodwill on one site has only been good for the one site.

In one embodiment, the activity or activities added to the profile are added as new entries. When the site 135 reads the profile, it just reads all the entries. Some entries may be new entries and other entries may be old entries. A process running in the profile reader 140 in the site reads the entries from the list, and determines which entries are new or otherwise need to be added to information in the site 135, and may also determine any new information that the site 135 has which needs to be added to the list.

FIG. 2 illustrates an exemplary process of reading and using the site and the profile.

In the FIG. 2 embodiment, the profile 101 may have combined portions of the profile that are secured activity 120, by virtue of them having been ‘signed’ by a secure site. For example, either the signing authority or the profile reading part 140 on the site to which the profile relates may read multiple entries, and combine multiple related entries into a combined profile entry. Uncombined portions of the profile may form the unsecured activity 130. These portions might not be signed.

FIG. 2 shows the profile as 200. As shown, the profile has an initial part 101 which has personal information about the users such as the user's name, address, credit card, biometric information, signature, and the like. Typically this information is personal to the user and will not change over time. The profile 200 also includes two different parts in this embodiment, a combined profile part 210 which has been combined from the individual information. For example, this may include a combined Facebook profile part 212 and a combined eBay profile part 214. The combined Facebook profile may include compiled information indicating that the user has for example 50 friends on Facebook, a list of those friends and a list of interconnection between those friends. The Facebook profile may also include lifestyle information, e.g, likes and dislikes. In a similar way, the combined eBay profile may include the number of positive transactions, and information about those transactions. These combined portions may be created by either the site itself (Facebook or Ebay in this embodiment) or by the signing authority.

The profile also includes an uncombined profile 220 which is raw data that has not yet been incorporated into the combined profile. For example, in addition to the combined eBay profile 214, the uncombined profile part may include raw data which at some point needs to be added to the eBay profile. Element 221 shows that on Sep. 6, 2000, the user rating on eBay went up by one so +1 on Sep. 6, 2000. On Sep. 7, 2000, 222 indicates that friend x was made on Facebook. At 223, this may indicate that on September 8 the user achieved wizard status for character XP on World of Warcraft. This uncombined information may be information, for example, received via a message, but not signed by the website itself, in one embodiment. For example, information may be received by messages, but not secured until the portion of the profile that represents the specific website is “rebuilt” by the website.

The user uses the profile 200 as part of interacting with the site at 230. Once logging into the site, the site reads the profile at 240, and adapts any new parts from other sites on to the current site. In operation, the site may read both the combined profile and the uncombined profile. Information from the uncombined profile may be maintained at a different level on the website and the information from a combined profile. For example, the information from the uncombined profile may be taken as up to date information, but might not be indicated as verified, until the information is actually signed by one of the creation sites.

The combined profile may be something that can only be compiled by the site itself. For example, only Facebook may be able to create a combined Facebook profile at 212. This may require Facebook to “sign” this profile to show cryptographically that the profile is accurate and verified by Facebook. While this embodiment shows Facebook being used to create a combined profile and sign it, it should be understood that the signing authority site, or any other trusted site, could create a combined profile.

The uncombined profile may be information which has occurred after the last time that a combined profile was created. That uncombined information may also be signed, or may be considered as less secure than the combined profile information. At any point, the site such as Facebook may take the combined Facebook information 212, and combine that with the uncombined information 222, creating a new combined profile and removing the uncombined information.

In one embodiment, shown in 245, the site has different kinds of members, including a confirmed member who has a profile or who has a combined/confirmed profile, and unconfirmed members who have either no profile or only an uncombined profile.

The confirmed members may have more security, and/or may receive additional abilities or permissions on the website. For example, some actions on the website, such as chat rooms, may be accessible only by those with confirmed profiles.

FIG. 4 illustrates the operation of forming the profile using the profile on the site.

The above has described use of the system on social networks, buying sites, and game sites. This can also be used to purchase items, and maintain information about credit score and purchase history. This can also be used for example by banks to provide a local indication of the users balance, for example, and/or to provide information of transactions that a user may have done. The profile may be locally stored or at least part of the profile may be locally stored. All of this may be carried out from a user computer, for example the user computer can store the profile that is used on the multiple sites.

Part of the cryptographic operation may also include verification of the user's true identity. This may be done by using an identification, or by any other feature. A cryptographically verified identity can produce certain advantages, including that it can prevent the user from simply registering again as a new user when the user doesn't like their profile, or when they have been banned from the site or for any other reason. Also, this may be used to prevent a user from saying they are something or someone other than what they really are. For example if the user is a 40-year-old male, use of a cryptographically verified identity may prevent that user from registering as a 15-year-old female.

According to another embodiment, sites have different kind of operations for different kinds of users. For example, the site may differentiate between confirmed members who have profiles and unconfirmed members who do not have profiles. The unconfirmed members may be prohibited from taking certain actions on the website.

Applications of the system may be used to maintain different information and use that different information among and for more than one website. The above has described how this can be used, for example, with an eBay type site of person-to-person purchasing. It can also be used with a gaming site such as World of Warcraft. The person-to person profile might be used in World of Warcraft to determine whether someone is trustworthy enough to for example carry out a person-to-person sale in that gaming site. It can be used for a social networking site, and the friends on the social networking site can also be used and/or recommendations can be used within the gaming site or within the person-to-person site. In a similar way to that discussed above, it can be used on the purchase website to determine information from the social networking site, such as do people on the social networking site vouch for the person or from the gaming site to see information from the gaming site to be used on the social networking site. In a similar way, and can be used on any of the sites to get information from any of the other sites. It can also be used to maintain credit score/purchase history and the like to purchase items. It can be used for a bank, to provide some kind of local indication of balance, credit score or the kinds of things that can be done.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while this only describes a few different kind of sites that can be used in this way, other kinds of sites can receive information in a similar way that shares the information with other sites.

Also, users may set specific privacy settings for each of the profile parts, e.g., on the sites or in the profile itself. For example, a user might set their facebook profile for sharing to “indicate number of friends only”, or “provide information only to people who are my facebook friends on other sites”.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PC1”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of interacting with a website, comprising:
using a profile on a social networking site, where the profile has information about activity on multiple different sites including the social networking site;
receiving from the social networking site, updates to the profile, said updates having different information about connections and lifestyle preferences on the social networking site; and
using said profile on a purchase site, the purchase site updating the profile with different information about purchases made on the purchase site;
where said social networking site is given information from the purchases made on the purchase site, and said purchase site is given information from the connections and lifestyle preferences on the social networking site;
wherein said profile includes a signature that represents an accuracy of the information therein.

2. A method as in claim 1, wherein said signature represents accuracy of only part of the information, and another part of the information does not have its accuracy represented by said signature.

3. A method as in claim 1, wherein said profile also has information about a status on a gaming site, and further comprising using said profile on said gaming site, said gaming site updating the profile with different information about the gaming site, and wherein the social networking site is given information about information on the gaming site from said profile.

4. A method as in claim 2, wherein said profile has a combined portion which represents a combination of information, and an uncombined profile portion, that represents uncombined information intended to be combined with said combined information.

5. A method as in claim 4, where said combined information has its accuracy represented by said signature, and said uncombined information does not have its accuracy represented by said signature.

6. A method as in claim 4, further comprising receiving an updated profile after interacting with a first site, where said first site is one of said social networking site, or said purchase site, and said updated profile has said combined portion for only said first site including more information after said interacting with said first site, and where said uncombined information relating to said first site has been removed after said interacting with said first site.

7. A method as in claim 3, wherein said profile on said social networking site includes information about friends, and likes and dislikes; said information on said gaming site includes information about status of characters on the gaming site; and said information on said purchase site includes a number of successful purchases that were made.

8. A computer product comprising a processor, and a memory storing executable instructions in a non-transitory form, that when executed, implement a program, for interacting with a website, comprising:
storing on the memory, a multi site profile, which has information for use on a social networking site which includes information about connections and lifestyle preferences on the social networking site, and on an item purchase site which includes information about successful items purchased on the item purchase site, and on a gaming website, which includes information about characters on the gaming website, and items associated with the profile, gaming website;
using said profile on the social networking site, and providing information from said item purchase site and said gaming website to said social networking site via said profile, and receiving updates having different information about connections and lifestyle preferences on the social networking site into said profile;
using said profile on said purchase site, and providing information from said social networking site and said gaming website to said purchase site, and receiving updates from the purchase site about purchases made on the purchase site; where said social networking site is given information from the purchases made on the purchase site; and
using said profile on said gaming site, and providing information from said social networking site and said purchase site to said gaming site, and receiving updates from said gaming site to said profile.

9. The computer product as in claim 8, wherein said profile includes a signature that represents an accuracy of the information therein.

10. The computer product as in claim 9, wherein said signature represents accuracy of only part of the information, and another part of the information does not have its accuracy represented by said signature.

11. The computer product as in claim 8, wherein said profile has a combined portion which represents a combination of information, and an uncombined profile portion, that represents uncombined information intended to be combined with said combined information.

12. The computer product as in claim 11, where said combined information has its accuracy represented by said signature, and said uncombined information does not have its accuracy represented by said signature.

13. The computer product as in claim 12, further comprising receiving an updated profile after interacting with a first site, where said first site is one of said social networking site, or said purchase site, or said gaming website and said updated profile has a combined portion for only said first site including more information after said interacting with said first site, and where said uncombined information relating to said first site has been removed after said interacting with said first site.

14. A method of operating a gaming website, comprising:
receiving a multi site profile on the gaming website, and reading said multi site profile to receive information for use on the gaming website,
said multi site profile including information from a social networking site which includes information about connections and lifestyle preferences on the social networking site, and including information from an item purchase site which includes information about successful items purchased on the item purchase site, and including information form said gaming website, which includes information about items on the gaming website;
said gaming website using information from at least one of said profile on the social networking site or said profile on the item purchase site to determine if a user has sufficient trust to carry out an action on said gaming website.

15. A method as in claim 14, further comprising receiving updates to said profile.

16. A method as in claim 14, wherein said profile includes a signature that represents an accuracy of the information therein.

17. A method as in claim 16, wherein said profile has a combined portion which represents a combination of information, and an uncombined profile portion, that represents uncombined information intended to be combined with said combined information.

18. A method as in claim 17, where said combined information has its accuracy represented by said signature, and said uncombined information does not have its accuracy represented by said signature.

19. A method as in claim 18, wherein said profile on said social networking site includes information about friends, and likes and dislikes; said information on said gaming site includes information about status of characters on the gaming site; and said information on said purchase site includes a number of successful purchases that were made.
